(19) United States
(12) Patent Application Publication
(10) Pub. No.: US 2024/0175101 A1
(43) Pub. Date: May 30, 2024

(54) REDUCED IRON PRODUCTION METHOD AND REDUCED IRON PRODUCTION DEVICE

(71) Applicant: JFE STEEL CORPORATION, Chiyoda-ku, Tokyo (JP)

(72) Inventors: Koki TERUI, Chiyoda-ku, Tokyo (JP); Takahide HIGUCHI, Chiyoda-ku, Tokyo (JP); Tetsuya YAMAMOTO, Chiyoda-ku, Tokyo (JP)

(73) Assignee: JFE STEEL CORPORATION, Chiyoda-ku, Tokyo (JP)

(21) Appl. No.: 18/551,597

(22) PCT Filed: Dec. 3, 2021
(86) PCT No.: PCT/JP2021/044582

§ 371 Date: Sep. 21, 2023

(30) Foreign Application Priority Data
Mar. 31, 2021 (JP) 2021-061960

(51) Int. Cl. C21B 13/02; C21B 13/00; C22B 1/16

(52) U.S. Cl. CPC C21B 13/02; C21B 13/0073; C22B 1/16

(57) ABSTRACT

Provided is a reduced iron production method that can efficiently produce reduced iron without preheating raw materials. The reduced iron production method includes charging an agglomerate, which is a raw material of reduced iron, into a reducing furnace while introducing a reducing gas, which contains hydrogen as a main component, into the reducing furnace, and reducing iron oxide contained in the agglomerate by the reducing gas to obtain reduced iron, where the agglomerate to be charged into the reducing furnace is an agglomerate that retains heat obtained during its production, and the heat is used in a reduction reaction of the iron oxide.

### TECHNICAL FIELD

This disclosure relates to a reduced iron production method and a reduced iron production device.

### BACKGROUND

Known methods of producing iron by reducing a raw material containing iron oxide include a blast furnace method where coke is used as a reducing agent to produce hot metal, a method where a reducing gas is used as a reducing agent and is blown into a vertical furnace (hereinafter referred to as “shaft furnace”), a method that also uses a reducing gas where the reducing gas reduces fine ore in a fluidized bed, a method where agglomeration and reduction of a raw material are integrated (rotary kiln method), and other methods.

These reduced iron production methods, except for the blast furnace method, use a reducing gas mainly composed of carbon monoxide (CO) or hydrogen (H₂) produced by reforming natural gas or coal as a reducing agent. Raw materials charged into a furnace are heated by convective heat transfer with the reducing gas, reduced, and then discharged out of the furnace. Oxidized gases such as water (H₂O) and carbon dioxide (CO₂), as well as H₂ gas and CO gas that do not contribute to the reduction reaction, are discharged out of the furnace.

The raw materials (mainly Fe₂O₃) charged into the furnace undergo reduction reactions represented by the following equations (1) and (2) with CO gas and H₂ gas, which are reducing gases.

Fe₂O₃+3CO→2Fe+3CO₂ (1)

Fe₂O₃+3H₂→2Fe+3H₂O (2)

That is, in the reduction by CO gas represented by the equation (1), CO₂ gas is discharged as emission gas after the reduction. On the other hand, in the reduction by H₂ gas represented by the equation (2), H₂O gas is discharged as emission gas after the reduction.

In recent years, because of the problem of global warming, it is necessary to decrease the amount of the reduction reaction by CO gas represented by the equation (1) and increase the amount of the reduction reaction by H₂ gas represented by the equation (2) to control emissions of CO₂, which is one of the greenhouse gases that cause global warming. To increase the amount of the reduction reaction by H₂ gas, the concentration of H₂ in the reducing gas used should be increased.

However, the reduction reactions by CO gas and H₂ gas differ in the amount of heat associated with each reaction. That is, the amount of heat of the reduction reaction by CO gas is +6710 kcal/kmol (Fe₂O₃), whereas the amount of the heat of the reduction reaction by H₂ gas is −22800 kcal/kmol (Fe₂O₃). In other words, the former is an exothermic reaction, whereas the latter is an endothermic reaction. Therefore, when the H₂ concentration in the reducing gas is increased to increase the amount of the reaction of the equation (2), a notable endothermic reaction occurs to lower the temperature inside the furnace, and the reduction reaction is stagnated. Therefore, it is necessary to compensate for the lack of heat by some means.

Against this background, JP 5630222 B (PTL 1) proposes a method of preheating raw materials that will be charged from the top of a reducing furnace to 100° C. or higher and 627° C. or lower to compensate for the heat absorbed by the reaction between H₂ gas and iron oxide.

### CITATION LIST

### Patent Literature

PTL 1: JP 5630222 B

### SUMMARY

### Technical Problem

However, the method proposed in PTL 1 requires a device to preheat the raw materials, which increases production costs.

It could thus be helpful to provide a reduced iron production method that can efficiently produce reduced iron without preheating raw materials.

### Solution to Problem

We thus provide the following.

[1] A reduced iron production method, comprising charging an agglomerate, which is a raw material of reduced iron, into a reducing furnace while introducing a reducing gas, which contains hydrogen as a main component, into the reducing furnace, and reducing iron oxide contained in the agglomerate by the reducing gas to obtain reduced iron, wherein
the agglomerate to be charged into the reducing furnace is an agglomerate that retains heat obtained during its production, and the heat is used in a reduction reaction of the iron oxide.

[2] The reduced iron production method according to aspect [1], wherein the agglomerate is charged directly into the reduction furnace after its production.

[3] The reduced iron production method according to aspect [1] or [2], wherein the reducing gas is hydrogen gas.

[4] A reduced iron production device that is used in the reduced iron production method as recited in any one of aspects [1] to [3], comprising
an agglomerate production section where the agglomerate is produced by agglomerating a raw material of the agglomerate, and
a reduction section having an agglomerate charging inlet for charging the agglomerate produced in the agglomerate production section, a reducing gas inlet for introducing the reducing gas, and a gas outlet for discharging the reducing gas that is not used in the reduction reaction and water formed in the reduction reaction, where in the reduction section, iron oxide contained in the agglomerate is reduced by the reducing gas to obtain reduced iron.

[5] The reduced iron production device according to aspect [4], wherein the reduction section is directly connected to the agglomerate production section.

[6] The reduced iron production device according to aspect [4] or [5], wherein the agglomerate production section and the reduction section are horizontal.

[7] The reduced iron production device according to aspect [4] or [5], wherein the reduction section is vertical.

### Advantageous Effect

According to the present disclosure, it is possible to provide a reduced iron production method that can efficiently produce reduced iron without preheating raw materials.

### BRIEF DESCRIPTION OF THE DRAWINGS

In the accompanying drawings:

FIG. 1 schematically illustrates a shaft furnace;

FIG. 2 illustrates an example of a reduced iron production device of the present disclosure; and

FIG. 3 illustrates the heat capacity of shaft furnaces in Examples and Comparative Examples.

### DETAILED DESCRIPTION

The following describes embodiments of the present disclosure with reference to the drawings. It should be noted that embodiments of the present disclosure are not limited to the following embodiments, if they do not depart from the gist of the present disclosure. The reduced iron production method of the present disclosure is a method of producing reduced iron by charging an agglomerate, which is a raw material of reduced iron, into a reducing furnace while introducing a reducing gas, which contains hydrogen as a main component, into the reducing furnace, and reducing the iron oxide contained in the agglomerate by the reducing gas to obtain reduced iron. As used herein, the agglomerate to be charged into the reducing furnace is an agglomerate that retains heat obtained during its production, and the heat is used in the reduction reaction of the iron oxide.

We have diligently studied a method of efficiently producing reduced iron without preheating an agglomerate which is a raw material of reduced iron. When conventionally producing reduced iron in a reducing furnace, finely powdered ore and a raw material that is usually called a pellet and is obtained by sintering fine ore into a spherical shape are used. Further, although the reduced iron is produced in a blast furnace, a raw material is usually sintered into sintered ore by a device called a sintering machine before being charged into the blast furnace. The temperature is usually raised to 1300° C. when baking the pellet, and the temperature is usually raised to around 1250° C. when baking the sintered ore. In this specification, the pellet and the sintered ore are collectively referred to as “agglomerate”.

The agglomerate produced as described above needs to be transported to a device (site) where it will be used. The temperature of the agglomerate immediately after production is around 1260° C. in the case of pellet and 800° C. to 1200° C. in the case of sintered ore. Therefore, there is a problem that if the agglomerate is transported on a belt conveyor or the like, the belt will burn. Conventionally, the produced agglomerates such as pellets or sintered ore are then charged into a device called a cooler to recover the sensible heat contained in these agglomerates. The recovered sensible heat is used for boilers, for example. Although the sensible heat possessed by the agglomerate is recovered and reused in this way, there is a loss of heat due to the many intermediate processes.

We came up with the idea of using the sensible heat possessed by the produced agglomerate, which is conventionally recovered by a cooler, as a heat source for the heat of the reduction reaction by H₂, thereby completing the present disclosure.

In the present disclosure, an agglomerate to be charged into a reducing furnace is an agglomerate that retains heat obtained during its production. As used herein, the term “agglomerate that retains heat obtained during its production” means an agglomerate that retains at least part of the heat given to a raw material such as iron ore powder during the production of a pellet or sintered ore after the production, and specifically it refers to an agglomerate with a temperature above room temperature (e.g., 25° C.). Therefore, an agglomerate that is naturally cooled after the production and before being transported to a reducing furnace, and an agglomerate that is intentionally cooled to a predetermined temperature above room temperature after the production and before being transported to a reducing furnace are included in the “agglomerate that retains heat obtained during its production”.

The temperature of the agglomerate ore to be charged into a reducing furnace is preferably high in terms of supplying the heat of the reduction reaction of oxide. Specifically, the temperature of the agglomerate ore to be charged into a reducing furnace is preferably 500° C. or higher, more preferably 600° C. or higher, still more preferably 700° C. or higher, and most preferably 800° C. or higher.

In the present disclosure, a gas containing H₂ as a main component is used as a reducing gas. In this specification, “a gas containing H₂ as a main component” means a gas with a H₂ concentration of 50% by volume or more. This can reduce CO₂ emissions.

The H₂ concentration of the reducing gas is preferably 65% by volume or more. This can further enhance the effect of reducing CO₂ emissions. The H₂ concentration of the reducing gas is more preferably 70% by volume or more, still more preferably 80% by volume or more, even more preferably 90% by volume or more, and most preferably 100% by volume, that is, it is most preferable to use H₂ gas as the reducing gas. By using H₂ gas as the reducing gas, reduced iron can be produced without CO₂ emissions.

The temperature of the reducing gas introduced into a reducing furnace is preferably 800° C. or higher. The temperature of the reducing gas introduced into a reducing furnace is preferably 1000° C. or lower. The reaction rate is increased by setting the temperature of the reducing gas to 800° C. or higher, and the reaction rate increases as the temperature increases. However, if the temperature of the reducing gas becomes too high, a so-called clustering phenomenon occurs in which the agglomerates adhere to each other, and the agglomerates become large in the furnace, which deteriorates the transportability. Therefore, the temperature of the reducing gas is preferably 1000° C. or lower. The temperature of the reducing gas is more preferably 860° C. or higher. The temperature of the reducing gas is more preferably 950° C. or lower.

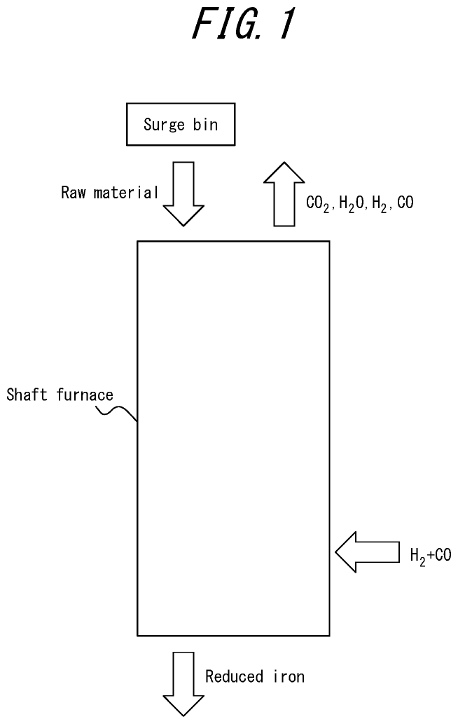

The following describes the reduced iron production method of the present disclosure, taking a case of using a shaft furnace, which is a vertical furnace, as a reducing furnace as an example. FIG. 1 schematically illustrates a shaft furnace. The shaft furnace illustrated in FIG. 1 has a surge bin at the top of the furnace for storing agglomerates that are raw materials of reduced iron, and the agglomerate that retains heat obtained during its production is charged from an agglomerate charging inlet at the top of the furnace. On the other hand, a reducing gas inlet is provided in the lower part of the furnace, and a reducing gas, which is a mixed gas of CO gas and H₂ gas produced by reforming natural gas and contains H₂ as a main component, is blown in, for example.

The agglomerate, which is a raw material charged into the furnace, is heated by heat exchange with the reducing gas, and the iron oxide contained in the agglomerate is reduced by the reactions represented by the equations (1) and (2). In this process, the heat possessed by the agglomerate compensates for the heat absorbed by the reaction of the equation (2), so that the stagnation of the reduction reaction can be suppressed and reduced iron can be obtained efficiently. The resulting reduced iron is discharged out of the furnace from the lower part of the furnace.

In the present disclosure, it is preferable to charge the agglomerate, which is a raw material of reduced iron, directly into the reducing furnace after its production. In this case, more sensible heat can be supplied to the reduction reaction of iron oxide by H₂ gas in the reducing furnace than otherwise. The words “charging the agglomerate directly into the reducing furnace after its production” mean charging the produced agglomerate into the reducing furnace without any intervening process that intentionally treats the agglomerate (except for a process of transporting the agglomerate), such as cooling the agglomerate in a cooler.

For example, a pellet baked by a rotary kiln for pellet baking is preferably not transported to the cooler for sensible heat recovery described above, but directly transported into the surge bin located at the top of the shaft furnace. During the transport, a form like a fire extinguisher used in a coke oven may be used to prevent a belt conveyor from burning out due to the hot pellet. When the pellets are transported to the surge bin at the top of the furnace, they may be transported in batches using a skip car or the like. When using sintered ore as the agglomerate, the same transportation mode as that for the pellet may be employed.

To reduce the amount of heat exhausted from the baked agglomerate, the distance from the agglomerate production process to the reduced iron production process is preferably shortened as much as possible in the reduced iron production method of the present disclosure.

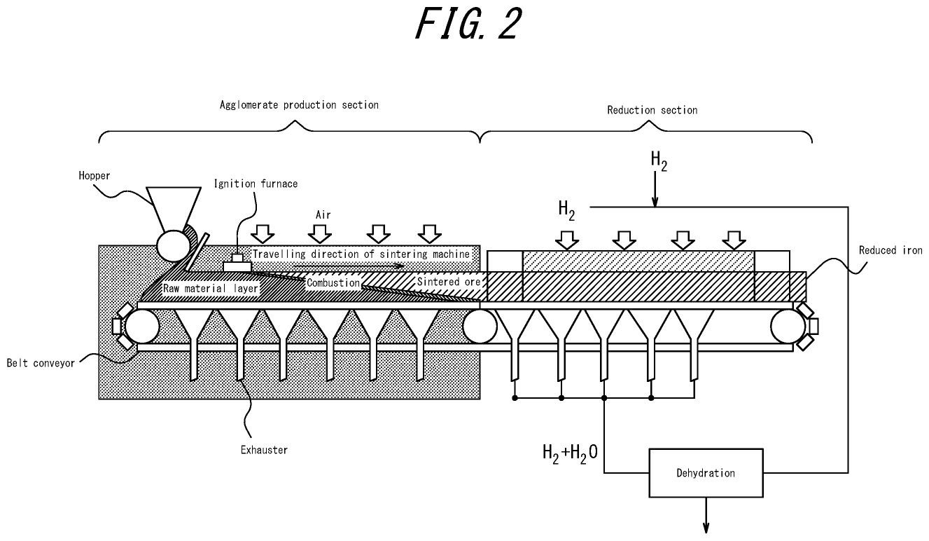

FIG. 2 illustrates an example of a reduced iron production device that can be used in the reduced iron production method of the present disclosure. The device illustrated in FIG. 2 is a horizontal reduced iron production device, including an agglomerate production section in which an agglomerate is produced by agglomerating a raw material of an agglomerate, and a reduction section in which reduced iron is obtained by reducing iron oxide contained in an agglomerate by a reducing gas. The reduction section has an agglomerate charging inlet for charging agglomerates produced in the agglomerate production section, a reducing gas inlet for introducing the reducing gas, and a gas outlet for discharging the reducing gas that is not used in the reduction reaction and the gas formed in the reduction reaction.

In the device illustrated in FIG. 2, the reduction section is directly connected to and is adjacent to the agglomerate production section (that is, the two sections are arranged side-by-side). This allows an immediate transition from the agglomerate production process to the reduction process of iron oxide contained in the agglomerate, and the reduction treatment can be continuously performed without discharging the produced agglomerate out of the system. The words “the reduction section is directly connected to the agglomerate production section” mean that there is no configuration (except for a means of transporting the agglomerate) between the agglomerate production section and the reduction section that intentionally treats the agglomerate, such as a configuration for cooling the agglomerate like a cooler.

In the agglomerate production section, a raw material of agglomerated ore such as iron ore powder is supplied from a hopper onto a belt conveyor, and a raw material layer consisting of the supplied raw material is ignited by an ignition furnace or the like from the top of the raw material layer, and air is sucked in by exhausters under the raw material layer at the same time. As a result, a combustion area above the raw material layer gradually moves downward, and the entire raw material layer is baked from top to bottom to obtain agglomerates.

In the reduction section, a belt conveyor charges the agglomerates produced in the agglomerate production section from the agglomerate charging inlet into the reduction section at a constant speed. At the same time, a reducing gas such as H₂ gas is introduced into the furnace through the reducing gas inlet located at the top of the reduction section, and the oxides contained in the agglomerates are reduced by the reducing gas to obtain reduced iron. The resulting reduced iron is discharged from the reducing furnace and collected. On the other hand, exhausters discharge the reducing gas that is not used in the reduction reaction as well as the water formed in the reduction reaction from the outlet located at the lower part of the furnace. The discharged reducing gas is dehydrated, then led to the top of the reduction section, mixed with fresh reducing gas, and reintroduced into the reduction section. Reduced iron can be produced continuously in this way.

Although the device illustrated in FIG. 2 is a horizontal device, the reduction section may be composed of a shaft furnace like the vertical furnace illustrated in FIG. 1.

### EXAMPLES

The following describes examples of the present disclosure, but the present disclosure is not limited to the following examples.

To confirm the effectiveness of the reduced iron production method of the present disclosure, the reduction rate of a product (reduced iron) was calculated using a heat-mass balance model in a case where a shaft furnace was used as a reducing furnace.

### Comparative Example 1

Reduced iron was produced according to a current method using a shaft furnace. Specifically, a mixed gas with a CO concentration of 38% by volume and a H₂ concentration of 62% by volume was used as a reducing gas. The temperature of the agglomerated ore charged from the top of the shaft furnace was set to 25° C., the temperature of the reducing gas introduced from the lower part of the shaft furnace was set to 950° C., and the blast volume of the reducing gas was set to 2200 Nm³/t. As a result, the reduction rate of the reduced iron as a product was 91.7%. The conditions for producing the reduced iron, the heat flow ratio, and the reduction rate of the product are listed in Table 1.

TABLE 1

| | Comparative | Comparative | | |
|---|---|---|---|---|
| | Example 1 | Example 2 | Example 1 | Example 2 |
| CO concentration of reducing gas (% by volume) | 38 | 0 | 0 | 0 |
| H₂ concentration of reducing gas (% by volume) | 62 | 100 | 100 | 100 |
| Temperature of reducing gas (° C.) | 950 | 950 | 950 | 950 |
| Temperature of agglomerate ore charged (° C.) | 25 | 25 | 500 | 800 |
| Blast volume of reducing gas (Nm³/t) | 2200 | 2200 | 1405 | 1252 |
| Heat flow ratio | 0.63 | 0.97 | 0.63 | 0.63 |
| Reduction rate of product (%) | 91.7 | 30.5 | 90.1 | 90.7 |

### Comparative Example 2

Reduced iron was produced as in Comparative Example 1. However, H₂ gas (gas with a hydrogen concentration of 100% by volume) was used as a reducing gas. All other conditions were the same as in Comparative Example 1. As a result, the reduction rate of the product was 30.5%. The conditions for producing the reduced iron and the reduction rate of the product are listed in Table 1.

### Example 1

Reduced iron was produced as in Comparative Example 1. However, H₂ gas (gas with a hydrogen concentration of 100% by volume) was used as a reducing gas, and the temperature of the agglomerated ore charged into the reducing furnace was set to 500° C. The blast volume of the reducing gas was set so that the heat flow ratio was the same as in Comparative Example 1, as will be described later. All other conditions were the same as in Comparative Example 1. As a result, the reduction rate of the product was 90.1%. The conditions for producing the reduced iron and the reduction rate of the product are listed in Table 1.

### Example 2

Reduced iron was produced as in Example 1. However, the temperature of the agglomerated ore charged into the reducing furnace was set to 800° C. The blast volume of the reducing gas was set so that the heat flow ratio was the same as in Comparative Example 1, as will be described later. All other conditions were the same as in Example 1. As a result, the reduction rate of the product was 90.7%. The conditions for producing the reduced iron and the reduction rate of the product are listed in Table 1.

### <Evaluation of Reduction Rate of Product>

As indicated in Table 1, in Comparative Example 1 where reduced iron was produced under the current conditions, the reduction rate of the product was 91.7%, whereas in Comparative Example 2, the reduction rate of the product dropped significantly to 30.5% due to a large increase in the H₂ concentration of the reducing gas to 100% by mass. On the other hand, in Examples 1 and 2, even if the hydrogen concentration of the reducing gas was 100% by mass, the reduction rate was almost equal to that of Comparative Example 1, which confirms that reduced iron can be efficiently produced according to the present disclosure.

### <Evaluation of Heat Capacity of Shaft Furnace>

In a vertical countercurrent moving bed such as a blast furnace or a shaft furnace, the heat flow ratio is one of the indicators for determining whether or not the temperature of a raw material is sufficiently raised and the process is feasible. The heat flow ratio is the value obtained by dividing the product (heat capacity) of the flow rate and the specific heat of the charged raw material by the product of the flow rate and the specific heat of the gas blown into the furnace, and it is a parameter that greatly affects the temperature distribution of the charged material and gas in the furnace.

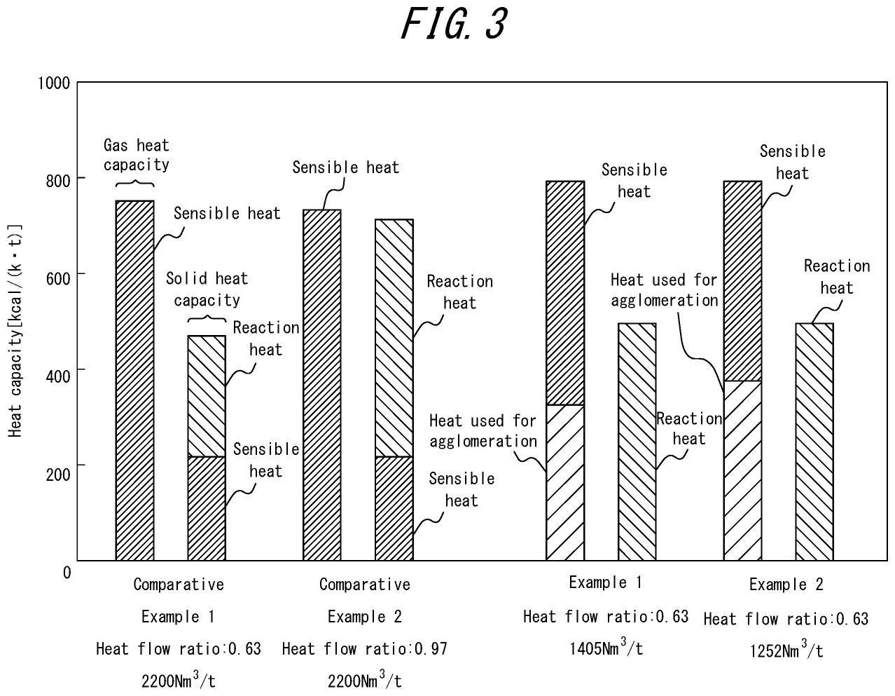

FIG. 3 illustrates the heat capacity of the shaft furnaces in Examples and Comparative Examples. First, in the shaft furnace in Comparative Example 1 where reduced iron was produced according to a current method, the heat flow ratio calculated based on the heat capacities of the reducing gas and the agglomerate was 0.63 under a set of conditions where the blast volume of the reducing gas was 2200 Nm³/t, the H₂ concentration was 38% by volume, and the CO concentration was 62% by volume. Note that the unit Nm³/t represents the amount of reducing gas required to produce one ton of reduced iron. The heat capacity of the reducing gas was calculated based on the sensible heat of the reducing gas, and the heat capacity of the agglomerate was calculated based on the values of the sensible heat and the reduction reaction heat.

On the other hand, in Comparative Example 2 where the H₂ concentration of the reducing gas was 100% by volume, the endothermic reaction due to H₂ was accelerated, and the heat flow ratio calculated based on the heat capacities was 0.97. In this case, since the heat capacity of the reducing gas and the heat capacity of the agglomerate as a raw material are antagonistic to each other, there is a concern that the temperature rise of the agglomerate may be delayed and the reduction of the iron oxide contained in the agglomerate may be stagnated, resulting in a low reduction rate in a product. On the other hand, in the cases of Examples 1 and 2, it is possible to maintain a heat flow ratio of 0.63, which is equivalent to that of a current shaft furnace, by maintaining the temperature of the agglomerate at a high temperature during charging, even when the H₂ concentration of the reducing gas is 100% by volume. Further, when the heat flow ratio is 0.63, it is possible to reduce the amount of reducing gas blown into the furnace from 2200 Nm³/t as in Comparative Example 1 to 1405 Nm³/t (Example 1) and 1252 Nm³/t (Example 2).

### INDUSTRIAL APPLICABILITY

According to the present disclosure, it is possible to provide a reduced iron production method that can efficiently produce reduced iron without preheating raw materials, which is useful in the steel industry.

1. A reduced iron production method, comprising charging an agglomerate, which is a raw material of reduced iron, into a reducing furnace while introducing a reducing gas, which contains hydrogen as a main component, into the reducing furnace, and reducing iron oxide contained in the agglomerate by the reducing gas to obtain reduced iron, wherein
the agglomerate to be charged into the reducing furnace is an agglomerate that retains heat obtained during its production, and the heat is used in a reduction reaction of the iron oxide.

2. The reduced iron production method according to claim 1, wherein the agglomerate is charged directly into the reduction furnace after its production.

3. The reduced iron production method according to claim 1, wherein the reducing gas is hydrogen gas.

4. A reduced iron production device that is used in the reduced iron production method according to claim 1, comprising
an agglomerate production section where the agglomerate is produced by agglomerating a raw material of the agglomerate, and
a reduction section having an agglomerate charging inlet for charging the agglomerate produced in the agglomerate production section, a reducing gas inlet for introducing the reducing gas, and an outlet for discharging the reducing gas that is not used in the reduction reaction and water formed in the reduction reaction, where in the reduction section, iron oxide contained in the agglomerate is reduced by the reducing gas to obtain reduced iron.

5. The reduced iron production device according to claim 4, wherein the reduction section is directly connected to the agglomerate production section.

6. The reduced iron production device according to claim 4, wherein the agglomerate production section and the reduction section are horizontal.

7. The reduced iron production device according to claim 4, wherein the reduction section is vertical.

8. The reduced iron production method according to claim 2, wherein the reducing gas is hydrogen gas.

9. A reduced iron production device that is used in the reduced iron production method according to claim 2, comprising
an agglomerate production section where the agglomerate is produced by agglomerating a raw material of the agglomerate, and
a reduction section having an agglomerate charging inlet for charging the agglomerate produced in the agglomerate production section, a reducing gas inlet for introducing the reducing gas, and an outlet for discharging the reducing gas that is not used in the reduction reaction and water formed in the reduction reaction, where in the reduction section, iron oxide contained in the agglomerate is reduced by the reducing gas to obtain reduced iron.

10. A reduced iron production device that is used in the reduced iron production method according to claim 3, comprising
an agglomerate production section where the agglomerate is produced by agglomerating a raw material of the agglomerate, and
a reduction section having an agglomerate charging inlet for charging the agglomerate produced in the agglomerate production section, a reducing gas inlet for introducing the reducing gas, and an outlet for discharging the reducing gas that is not used in the reduction reaction and water formed in the reduction reaction, where in the reduction section, iron oxide contained in the agglomerate is reduced by the reducing gas to obtain reduced iron.

11. A reduced iron production device that is used in the reduced iron production method according to claim 8, comprising
an agglomerate production section where the agglomerate is produced by agglomerating a raw material of the agglomerate, and
a reduction section having an agglomerate charging inlet for charging the agglomerate produced in the agglomerate production section, a reducing gas inlet for introducing the reducing gas, and an outlet for discharging the reducing gas that is not used in the reduction reaction and water formed in the reduction reaction, where in the reduction section, iron oxide contained in the agglomerate is reduced by the reducing gas to obtain reduced iron.

12. The reduced iron production device according to claim 9, wherein the reduction section is directly connected to the agglomerate production section.

13. The reduced iron production device according to claim 10, wherein the reduction section is directly connected to the agglomerate production section.

14. The reduced iron production device according to claim 11, wherein the reduction section is directly connected to the agglomerate production section.

15. The reduced iron production device according to claim 9, wherein the agglomerate production section and the reduction section are horizontal.

16. The reduced iron production device according to claim 10, wherein the agglomerate production section and the reduction section are horizontal.

17. The reduced iron production device according to claim 11, wherein the agglomerate production section and the reduction section are horizontal.

18. The reduced iron production device according to claim 9, wherein the reduction section is vertical.

19. The reduced iron production device according to claim 10, wherein the reduction section is vertical.

20. The reduced iron production device according to claim 11, wherein the reduction section is vertical.
